(19) United States
(12) Patent Application Publication
(10) Pub. No.: US 2009/0160962 A1
(43) Pub. Date: Jun. 25, 2009

(54) VIBRATION PREVENTION CONTROL CIRCUIT OF IMAGING DEVICE

(75) Inventors: Yoshihisa TABUCHI, Gifu (JP); Yuuki TASHITA, Gifu (JP); Yasuhisa YAMADA, Aichi (JP)

Correspondence Address: CANTOR COLBURN, LLP, 20 Church Street, 22nd Floor, Hartford, CT, 06103, US

(73) Assignees: SANYO ELECTRIC CO., LTD., Osaka (JP); SANYO SEMICONDUCTOR CO., LTD., Gunma (JP)

(21) Appl. No.: 12/343,646

(22) Filed: Dec. 24, 2008

(30) Foreign Application Priority Data
Dec. 25, 2007 (JP) 2007-332466

(51) Int. Cl. H04N 5/225

(52) U.S. Cl. 348/208.99; 348/E05.024

(57) ABSTRACT

A vibration prevention control circuit is provided that comprises at least one analog-to-digital converter circuit which samples and converts an output signal of a vibration detection element which detects vibration of an imaging device and an output signal of a position detection element which detects a position of an optical component, into digital signals, a vibration component processor that processes the output signal of the vibration detection element which is digitized by the analog-to-digital converter circuit, a down-sampling unit that down-samples the output signal of the vibration detection element which is processed by the vibration component processor, and a servo circuit that generates a control signal which drives the optical component, based on the output signal of the vibration detection element which is output from the down-sampling unit and the output signal of the position detection element which is digitized by the analog-to-digital converter circuit.

### CROSS-REFERENCE TO RELATED APPLICATION

The disclosure of Japanese Patent Application No. 2007-332466 including specification, claims, drawings, and abstract is incorporated herein by reference.

### BACKGROUND OF THE INVENTION

1. Field of the Invention

The present invention relates to a vibration prevention control circuit which is equipped in an imaging device.

2. Description of the Related Art

Recently, imaging devices such as a digital still camera and a digital video camera realize improved image quality by increasing a number of pixels of an imaging element provided in the imaging device. On the other hand, as another method of realizing improved image quality for the imaging device, it is desired for the imaging device to have a vibration correction function in order to prevent vibration of an image of an object caused by vibration of the hand holding the imaging device.

More specifically, a detection element such as a gyro sensor is provided in an imaging device, and optical components such as the lens and the imaging element are driven according to an angular velocity component caused by vibration of the imaging device, to prevent vibration of the object image. With this structure, even if the imaging device is vibrated, the component of the vibration is not reflected in the obtained image signal, and an image signal having no image vibration and a high image quality can be acquired.

FIG. 4 is a block diagram of a vibration prevention control circuit 100 of the related art which is used for realizing the vibration prevention function. The vibration prevention control circuit 100 is provided in an imaging device, and operates according to control of a main control circuit (not shown) provided in the imaging device. The vibration prevention control circuit 100 is connected to a position detection element 102, a lens driving element 104, and a vibration detection element 106.

The position detection element 102 detects a position of a lens which is used in the imaging device. A hall element may be used as the position detection element 102. The hall element produces an inductive current corresponding to an absolute position of the lens and outputs a voltage signal to the vibration prevention control circuit 100. A voice coil motor may be used as the lens driving element 104. The vibration prevention control circuit 100 controls a position of a movable coil of the voice coil motor, that is, a position of the lens with respect to an optical axis which forms a reference, by adjusting the value of the voltage to be applied to the lens driving element 104. The lens driving element 104 drives the lens within a plane which is perpendicular to the reference optical axis of the imaging device. The vibration detection element 106 detects vibration of the imaging device and outputs the result of the detection to the vibration prevention control circuit 100. A gyro sensor may be employed as the vibration detection element 106. The vibration detection element 106 generates an angular velocity signal corresponding to the vibration applied to the imaging device and outputs the angular velocity signal to the vibration prevention control circuit 100.

For each of the position detection element 102, the lens driving element 104, and the vibration detection element 106, it is desired for at least two elements to be provided. For example, a plurality of elements are provided corresponding to a horizontal component and a vertical component in a plane perpendicular to the optical axis of the imaging device, and the lens position detection, lens movement, and vibration detection of the imaging device are executed.

Next, the vibration prevention control circuit 100 will be described in detail. The vibration prevention control circuit 100 comprises a servo circuit 10, a lens driver 12, an analog-to-digital converter circuit (ADC) 14, a CPU 16, and a digital-to-analog converter circuit (DAC) 18.

The servo circuit 10 generates a signal for controlling the lens driving element 104 according to the voltage signal which is output from the position detection element 102. The servo circuit 10 comprises an analog filter circuit including an external resistor element, a capacitor, etc., and generates a signal which controls the lens driving element 104 such that the optical axis of the lens matches the center of the imaging element provided in the imaging device. The lens driver 12 generates a lens driving signal which drives the lens driving element 104 based on the signal which is output from the servo circuit 10.

The ADC 14 converts the analog angular velocity signal which is output from the vibration detection element 106 into a digital signal. The CPU 16 generates an angle signal which indicates an amount of movement of the imaging device based on the digital angular velocity signal. The CPU 16 is connected to a memory (not shown) and executes the generation process of the angle signal based on software stored in the memory. The DAC 18 converts the digital angle signal generated by the CPU 16 into an analog signal.

The servo circuit 10 generates a signal which controls the lens driving element 104 according to a signal in which the analog angle signal which is output from the DAC 18 and the voltage signal which is output from the position detection element 102 are added. In other words, in order to prevent vibration of an object image due to hand vibration, the position of the lens is changed based on the angle signal indicating the amount of movement of the imaging device, to inhibit vibration of the image of the object on the imaging element. With this structure, the vibration of the object image due to the vibration of the hand can be inhibited and an image signal of high image quality can be obtained.

In order to facilitate changing of an adjustment value of the filter provided in the vibration prevention control circuit, it is desired to replace the servo circuit, the lens driver, and the processor circuit of the vibration detection signal with logic circuits which can digitally process. In addition, because the vibration prevention control circuit is equipped in an imaging element such as a digital camera or the like or a lens module of the imaging element, the size must be minimized even when logic circuits are employed.

The angular velocity signal which is output from the vibration detection element 106 is integrated so that the angular velocity signal is converted into a signal indicating the angle (position) of the vibration, and the signal is used as a reference for comparison to a signal indicating the position of the optical element which is output from the position detection element 102, so that a driving signal which controls the position of the optical element is generated.

In this case, because the angular velocity signal can be considered as a superposition of sine waves (or cosine waves), when the angular velocity signal is integrated with respect to time, the phase is shifted by 90°. However, the vibration prevention control circuit includes a circuit which processes the angular velocity signal, and the phase of the angle signal obtained by the integration circuit would be deviated by these circuits. Because of this, a signal in which the phase is shifted by 90° cannot be obtained. There is a problem in that, because of this deviation, the angle (position) signal obtained based on the output signal from the vibration detection element 106 cannot be accurately compared to the position signal which is output from the position detection element 102.

### SUMMARY OF THE INVENTION

According to one aspect of the present invention, there is provided a vibration prevention control circuit that drives an optical component of an imaging device according to vibration and that reduces the influence of the vibration on imaging, the vibration prevention control circuit comprising at least one analog-to-digital converter circuit that samples and converts an output signal of a vibration detection element which detects vibration of the imaging device and an output signal of a position detection element which detects a position of the optical component, into digital signals, a vibration component processor that processes the output signal of the vibration detection element which is digitized by the analog-to-digital converter circuit, a down-sampling unit that down-samples the output signal of the vibration detection element which is processed by the vibration component processor, and a servo circuit that generates a control signal which drives the optical component, based on the output signal of the vibration detection element which is output from the down-sampling unit and the output signal of the position detection element which is digitized by the analog-to-digital converter circuit.

### BRIEF DESCRIPTION OF THE DRAWINGS

Preferred embodiments of the present invention will be described in detail based on the following figures, wherein:

FIG. 1 is a diagram showing a structure of a vibration prevention control circuit in a preferred embodiment of the present invention;

FIG. 2 is a diagram showing an example phase characteristic of a vibration prevention control circuit;

FIG. 3 is a timing chart showing a down-sampling process in a preferred embodiment of the present invention; and

FIG. 4 is a diagram showing a structure of a vibration prevention control circuit in the related art.

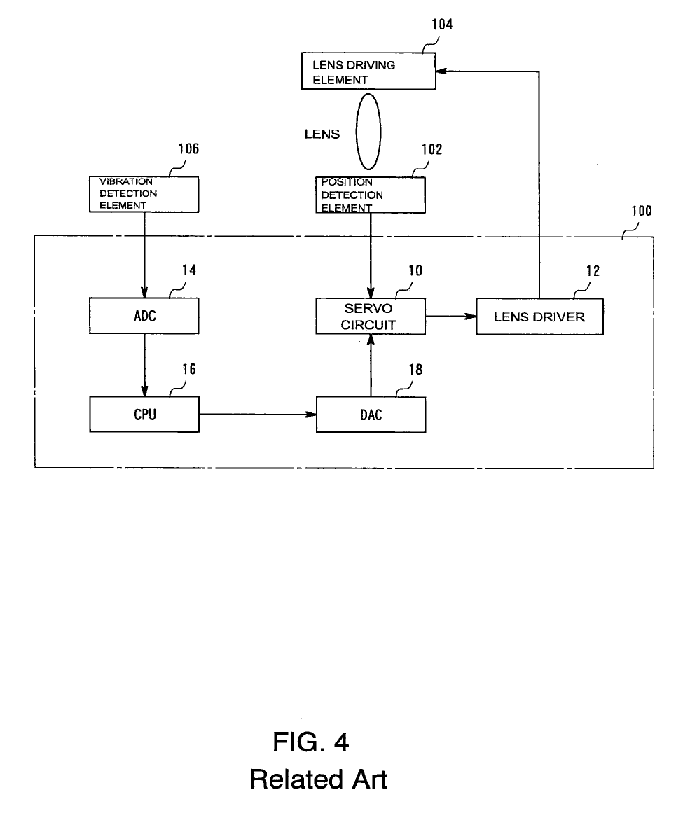

### DESCRIPTION OF THE PREFERRED EMBODIMENT

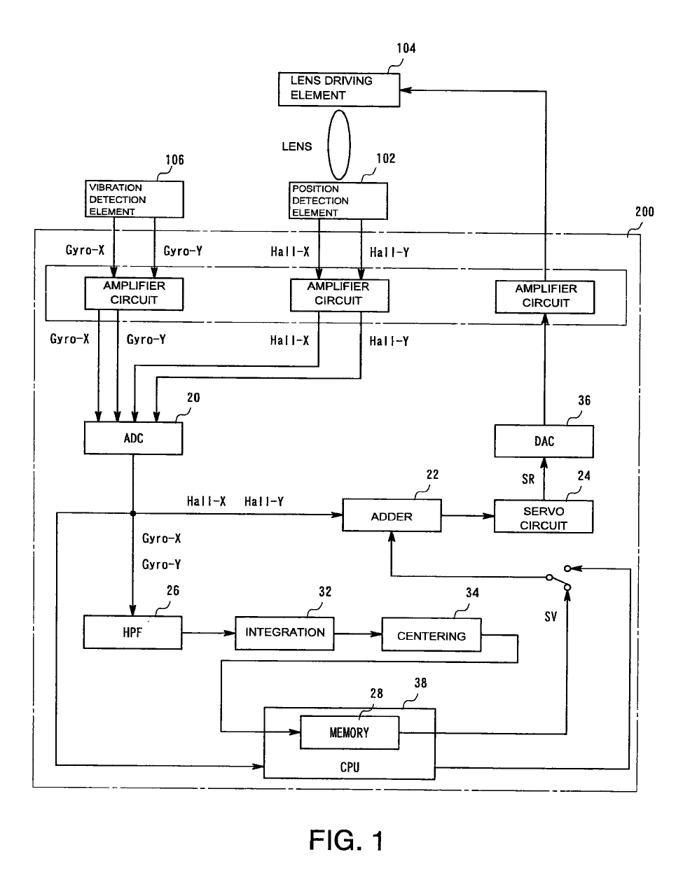

As shown in a functional block diagram of FIG. 1, a vibration prevention control circuit 200 in a preferred embodiment of the present invention comprises an analog-to-digital converter circuit (ADC) 20, an adder circuit 22, a servo circuit 24, a high-pass filter (HPF) 26, an integration circuit 32, a centering processor circuit 34, a memory 28, a digital-to-analog converter circuit (DAC) 36, and a CPU 38.

The vibration prevention control circuit 200 is connected to a position detection element 102, a lens driving element 104, and a vibration detection element 106. These elements are similar to those described above with reference to the related art. In other words, the position detection element 102 is provided for at least two axes so that the position of the lens driven by the lens driving element 104 can be measured in a manner to allow at least an orthogonal conversion, and the vibration detection element 106 is also provided for at least two axes so that the components of the vibration can be orthogonally converted along two axes in a yaw direction and a pitch direction.

The present embodiment is described with reference to an example case in which the position detection element 102 and the vibration detection element 106 are provided so that the lens position and vibration can be detected for the yaw direction (X-axis direction) and the pitch direction (Y-axis direction) of the imaging device. In the following description, the output signals of the position detection element 102 and the vibration detection element 106 are processed, such as an addition between the X-axis components of the output signals and between the Y-axis components of the output signals, and the lens position is controlled in the yaw direction (X-axis direction) and the pitch direction (Y-axis direction) based on the processed signals.

The ADC 20 converts an analog voltage signal which is output from the position detection element 102, for example, the hall element, in to a digital signal. The hall element generates an inductive current corresponding to a magnetic force using a magnet which is fixed on the lens. In other words, the hall element outputs a voltage signal which indicates the position of the lens according to a distance to the lens, and the ADC 20 converts the voltage signal into a digital signal and outputs the converted signal as a position signal. The ADC 20 has a structure in which a signal which indicates a reference, for example, a digital value of “0”, is output when the optical axis of the lens and the center of the imaging element provided in the imaging device match.

The ADC 20 also converts an analog angular velocity signal which is output from the vibration detection element 106, for example, a gyro sensor, into a digital signal. In other words, the ADC 20 digitizes the output signals from the position detection element 102 and the vibration detection element 106 in a time divisional manner and outputs the converted signals.

More specifically, the ADC 20 digitizes and outputs a signal of an X-axis component of vibration detected by the vibration detection element 106 (Gyro-X), a signal of a Y-axis component of vibration (Gyro-Y), a signal of an X-axis component of a position of the lens detected by the position detection element 102 (Hall-X), and a signal of a Y-axis component of the position (Hall-Y). The ADC 20 outputs the signals Gyro-X and Gyro-Y to the HPF 26 and the signals Hall-X and Hall-Y to the adder circuit 22.

The HPF 26 removes a direct current component included in the angular velocity signal which is the output signal of the vibration detection element 106 and extracts a high-frequency component of the angular velocity signal in which the vibration of the imaging device is reflected.

The integration circuit 32 integrates the angular velocity signals (Gyro-X and Gyro-Y) which are output from the HPF 26 and generates angle signals which indicate an amount of movement of the imaging device. Preferably, the integration circuit 32 comprises a digital filter (not shown), and determines the angle signal, that is, the amount of movement of the imaging device, by applying a filter process according to a filter coefficient which is set in a register (not shown).

The angular velocity signals (Gyro-X and Gyro-Y) are represented as a superposition of sine waves (sin waves), and the integration of the angular velocity signal may be considered equivalent to conversion to cosine waves (cos waves) in which the frequency components of the angular velocity signal are delayed by 90°.

The centering processor circuit 34 subtracts a predetermined value from the angle signal which is output from the integration circuit 32, and generates vibration component signals (SV-X and SV-Y) which indicate an amount of movement of the imaging device. When the vibration correction process is applied in the imaging device, there may be cases where the position of the lens is gradually moved apart from the reference position as the vibration correction process is continuously executed, and the position of the lens may reach a point near a limit point of the movable range of the lens. In this case, the continuation of the vibration correction process may result in a situation where the lens may be moved in a certain direction, but not in the other direction. The centering processor circuit 34 is provided in order to prevent this phenomenon, and applies control by subtracting a predetermined value from the angle signal so that the position of the lens does not easily reach the limit point of the movable range of the lens.

Preferably, the centering processor circuit 34 comprises a digital filter (not shown), and applies the process to subtract the predetermined value from the angle signal by applying a filter process according to a filter coefficient which is set in a register (not shown).

The memory 28 receives an output signal of the centering processor circuit 34 and stores and maintains the output signal in a predetermined memory region. The memory 28 receives a down-sampling number from the CPU 38, down-samples the vibration component signals (SV-X and SV-Y) according to the down-sampling number, and outputs the processed signal. The memory 28 may be, for example, a memory built in to the CPU 38. The memory 28 and the CPU 38 correspond to a down-sampling unit.

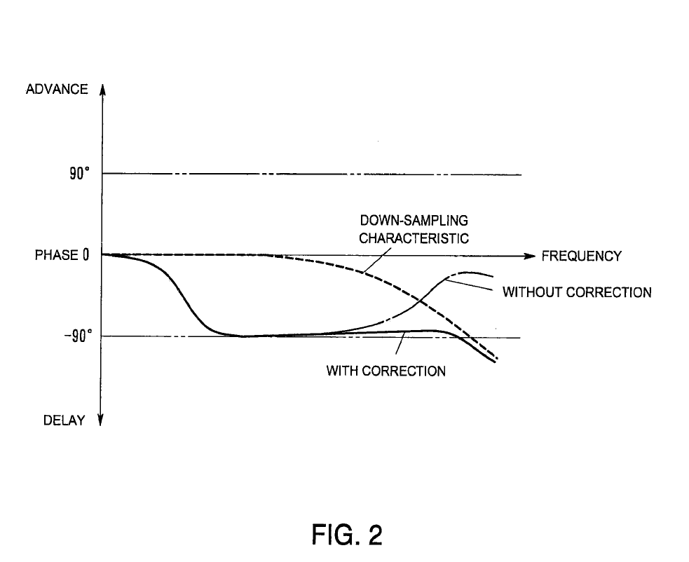

In general, a signal processed by the HPF 26, the integration circuit 32, and the centering processor circuit 34 has a state in which the phase is advanced from the ideal phase delay (−90°) as the frequency of the signal is increased, as shown by a one-dot-and-chain line of FIG. 2. Thus, as shown by a dotted line in FIG. 2, the signal is delayed by the memory 28 so that the phase delay is such as to approximately cancel the advance of the phase. With this configuration, it is possible to correct the signals to angle signals (SV-X and SV-Y) having an approximately ideal phase delay (−90°) in the frequency band of greater than or equal to 1 Hz and less than or equal to 20 Hz, in particular, the frequency band of greater than or equal to 2 Hz and less than or equal to 5 Hz which is necessary for the vibration correction process, as shown by a solid line of FIG. 2.

More specifically, a down-sampling process is applied to thin the output signals from the centering processor circuit 34. In other words, the sampling values of the signals stored in the memory 28 are output in a thinned manner so that a sampling period which is longer than the sampling period of the ADC 20 is achieved. The down-sampling process is applied on each of the vibration component signal of the X-axis component (SV-X) and the vibration component signal of the Y-axis component (SV-Y).

The CPU 38 sets various filter coefficients and control parameters of the servo circuit 24 included in the vibration prevention control circuit 200. In addition, the CPU 38 applies control to set a down-sampling number in the memory 28, so that the sampling values stored in the memory 28 are thinned by the down-sampling number, and output. In other words, the CPU 38 controls the output of the memory 28 so that the vibration component signals (SV-X and SV-Y) which are output from the memory 28 have a sampling period which is obtained by multiplying the sampling period at the ADC 20 by the down-sampling number. With this process, the vibration component signals (SV-X and SV-Y) which are output from the memory 28 become signals which are delayed by 90° compared to the vibration component signals (Gyro-X and Gyro-Y). The down-sampling number can be set in the CPU 38 in advance by measuring an amount of advance of the phase of the signal in the HPF 26, the integration circuit 32, and the centering processor circuit 34 in advance and setting in the CPU 38 for each vibration prevention control circuit 200 according to the measured amount.

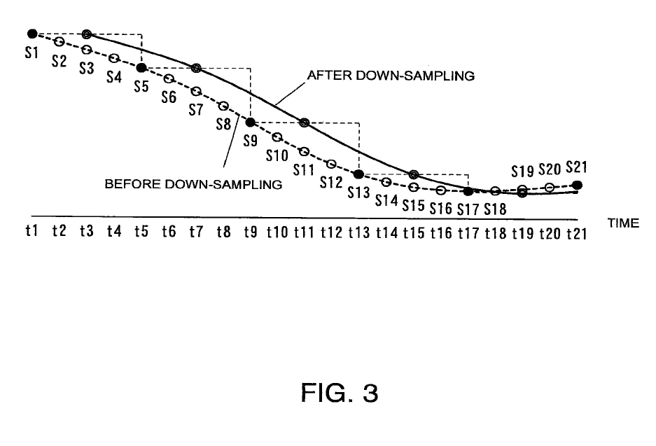

FIG. 3 shows an example configuration in which signals are output at a sampling period which is four times the sampling period in the ADC 20. The signal before the down-sampling stored in the memory 28 has sampling values of S1-S21 (black and white circles in FIG. 3) for each sampling time of t1-t21. Such a signal is down-sampled with a period which is four times the sampling period at the ADC 20 (black circle in FIG. 3).

With this process, the output signal from the memory 28 between time t1 and time t5 becomes the sampling value S1. In other words, the output signal becomes equivalent to a state in which the sampling value S1 is output at time t3 which is the average time of a time period from time t1 to time t5 (double circle in FIG. 3). The output signal from the memory 28 between time t5 and time t9 becomes the sampling value S5. In other words, the output signal becomes equivalent to a state in which the sampling value S5 is output at the time t7 which is the average time of a time period from time t5 to time t9 (double circle in FIG. 3). Similar down-sampling process applies to times later than t9.

When the down-sampling process is applied in this manner, the output signal from the memory 28 would have a zero^{th}-order hold characteristic, and becomes a signal (solid line in FIG. 3) which is delayed compared to the signal before the down-sampling process (dotted line in FIG. 3). The delay time τ is represented by the following equation (1).

$$\begin{matrix}[ Equation 1 ] & \\ Delay Time τ = \frac{Down \text{-} Sampling Number}{Sampling Frequency} \times \frac{1}{2} & ( 1 )\end{matrix}$$

Here, the sampling period refers to the sampling period at the ADC 20, and the down-sampling number is a multiplier for the sampling frequency during the down-sampling with respect to the sampling period at the ADC 20.

A phase difference between the position signal (Hall-X) which is input to the adder circuit 22 and the vibration component signal (SV-X) having the phase adjusted by the memory 28, and a phase difference between the position signal (Hall-Y) and the vibration component signal (SV-Y) having the phase adjusted by the memory 28, are each preferably 90° as shown by a one-dot-and-chain line of FIG. 3. However, as described above, the vibration component signals (SV-X and SV-Y) processed by the HPF 26, the integration circuit 32, and the centering processor circuit 34 have phases which are advanced by more than 90° compared to the position signals (Hall-X and Hall-Y) which are output from the ADC 20. Therefore, by using the CPU 38 to control the down-sampling number for the signals which are output from the memory 28, it is possible to control the delay time (phase adjustment) of the signals which are output from the memory 28 so that the signals reach the ideal state of delay of 90°.

The adder circuit 22 adds the position signal (Hall-X) which is output from the ADC 20 and the vibration component signal (SV-X) having the phase adjusted by the memory 28, and also adds the position signal (Hall-Y) which is output from the ADC 20 and the vibration component signal (SV-Y) having the phase adjusted by the memory 28, and outputs the resulting signals to the servo circuit 24.

The servo circuit 24 generates a correction signal SR for controlling the driving of the lens driving element 104, according to the output signals from the adder circuit 22. The servo circuit 24 comprises a register and a digital filter, and applies a filter process using a filter coefficient which is stored in the register.

The DAC 36 converts the digital correction signal SR into an analog signal. Based on the correction signal SR which is converted into an analog signal by the DAC 36, the lens driving element 104 drives the lens of the imaging device in the X-axis direction and in the Y-axis direction.

Movement control of the lens for correcting the vibration of the object image due to hand vibration using the vibration prevention control circuit 200 of FIG. 1 will now be described.

First, a case will be described in which there is no vibration of the object image due to hand vibration. Because the position of the lens driven by the lens driving element 104 is such that the optical axis of the lens and the center of the imaging element provided in the imaging device match, the ADC 20 outputs digital position signals (Hall-X and Hall-Y) which indicate “0”. The servo circuit 24 outputs a correction signal SR which controls the lens driving element 104 to maintain the current lens position when the values of the position signals (Hall-X and Hall-Y) are “0”.

When, on the other hand, the position of the lens and the center of the imaging element do not match, the ADC 20 outputs digital position signals (Hall-X and Hall-Y) showing values different from “0”. The servo circuit 24 outputs a correction signal SR which controls the lens driving element 104 so that the values of the position signals (Hall-X and Hall-Y) become “0”, according to the values which are output from the ADC 20. With repetition of the above-described operation, the vibration prevention control circuit 200 controls the position of the lens so that the position of the lens and the center of the imaging element match.

Next, a case will be described in which vibration of the object image is caused due to the hand vibration. Because the position of the lens driven by the lens driving element 104 is such that the optical axis of the lens and the center of the imaging element provided in the imaging device match, the ADC 20 outputs digital position signals (Hall-X and Hall-Y) indicating “0”. On the other hand, because the imaging device is moved due to the vibration of the hand, the integration circuit 32, the centering processor circuit 34, and the memory 28 output vibration component signals (SV-X and SV-Y) indicating an amount of movement of the imaging device.

In this process, in the vibration prevention control circuit 200 of the present embodiment, the CPU 38 controls the down-sampling number in the memory 28 so that the angular velocity signals (Gyro-X and Gyro-Y) are accurately delayed by 90°, and the vibration component signals (SV-X and SV-Y) which are angle signals (position signals) are input to the adder 22.

The servo circuit 24 generates a correction signal SR according to a signal in which the position signal (Hall-X) indicating “0” which is output from the ADC 20 and the vibration component signal of X-axis component (SV-X) which is output from the memory 28 are added. In this case, although the position signal (Hall-X) is “0”, because the vibration component signal (SV-X) which is not “0” is added, the servo circuit 24 generates a correction signal SR which moves the lens. The lens driving element 104 of X-axis is controlled according to the correction signal SR. Similarly, the servo circuit 24 generates a correction signal SR according to a signal in which the position signal (Hall-Y) indicating “0”, which is output from the ADC 20, and the vibration component signal of Y-axis component (SV-Y), which is output from the memory 28, are added. In this case, although the position signal (Hall-Y) is “0”, because the vibration component signal (SV-Y) which is not “0” is added, the servo circuit 24 generates the correction signal SR which moves the lens. The lens driving element 104 for the Y-axis is controlled according to the correction signal SR. Because the lens driving element 104 moves the lens based on the correction signal SR which is output from the servo circuit 24, the imaging element provided in the imaging device can obtain a signal in which the vibration of the object image due to the hand vibration is inhibited. By repeating such control, the vibration prevention control circuit 200 realizes the vibration correction control.

In the present embodiment, a structure is employed in which, when the angle signal indicating the amount of movement of the imaging device is generated based on the angular velocity signal obtained from the vibration detection element 106, the angle signal is generated using the HPF 26, the integration circuit 32, and the centering processor circuit 34. Because these circuits comprise digital filters, the filter coefficients can be easily changed. With such a configuration, the filter coefficient can be easily adjusted according to the system of the imaging device.

In addition, in the present embodiment, a structure is employed in which the vibration prevention control circuit 200 comprises the HPF 26, the integration circuit 32, the centering processor circuit 34, and the memory 28. With this structure, it is possible to reduce the circuit area compared to a structure in which the above-described processes are executed by the CPU 38. In this manner, it is possible to reduce the cost of the semiconductor chip on which the vibration prevention control circuit 200 is equipped.

Because the CPU 38 controls the down-sampling number at the memory 28, the angular velocity signals (Gyro-X and Gyro-Y) are accurately delayed by 90°. With this configuration, the angular velocity signals (Gyro-X and Gyro-Y) can be more accurately delayed by 90°, and the vibration correction process or the like can be executed with a higher precision, with accurate angle signals (SV-X and SV-Y). In particular, in the vibration correction for the angular velocity signals (Gyro-X and Gyro-Y), the frequency required for the process is low, and thus the influence of the down-sampling process, such as the distortion of the signal, is small, and the signals are suitable as a target to which the down-sampling process is applied.

Moreover, although in the present embodiment, a configuration is employed in which the hall element, the voice coil motor, and the gyro sensor are employed as the position detection element 102, the lens driving element 104, and the vibration detection element 106, the present invention is not limited to such a configuration. For example, a piezo element maybe used for the lens driving element 104. In addition, for the vibration detection element 106, a sensor which detects acceleration in a linear direction may be used and the vibration of the imaging device may be detected based on the acceleration signal.

In addition, a stepping motor may be used for the lens driving element 104. In this case, the high-pass filter 26, the integration circuit 32, and the centering processor circuit 34 generate an angle signal indicating the amount of movement of the imaging device based on the angular velocity signal detected by the position detection element 102. The vibration prevention control circuit 200 generates a pulse which drives the stepping motor based on the angle signal and outputs the generated pulse to the stepping motor. In this manner, a vibration correction system can be realized using the vibration prevention control circuit 200 and the stepping motor.

Although in the present embodiment, a lens shift method is employed in which the vibration correction process is executed by driving the lens, the present invention is not limited to such a configuration. For example, the present invention can be applied to a CCD shift method in which the imaging element such as the CCD element is shifted according to the vibration of the imaging device. In this case, the position detection element 102 may be set as an element which detects the position of the imaging element and the lens driving element 104 may be set as an element which drives the imaging element.

What is claimed is:

1. A vibration prevention control circuit that drives an optical component of an imaging device according to vibration and that reduces influence of the vibration on imaging, the vibration prevention control circuit comprising:
at least one analog-to-digital converter circuit that samples and converts an output signal of a vibration detection element which detects vibration of the imaging device and an output signal of a position detection element which detects a position of the optical component, into digital signals;
a vibration component processor that processes the output signal of the vibration detection element which is digitized by the analog-to-digital converter circuit;
a down-sampling unit that down-samples the output signal of the vibration detection element which is processed by the vibration component processor; and
a servo circuit that generates a control signal which drives the optical component, based on the output signal of the vibration detection element which is output from the down-sampling unit and the output signal of the position detection element which is digitized by the analog-to-digital converter circuit.

2. The vibration prevention control circuit according to claim 1, wherein
the down-sampling unit samples the output signal of the vibration detection element which is processed by the vibration component processor at a sampling period that is longer than a sampling period for the output signal of the vibration detection element at the analog-to-digital converter circuit, and outputs the sampled signal.

3. The vibration prevention control circuit according to claim 1, wherein
the down-sampling unit comprises:
a memory that stores and maintains the output signal of the vibration detection element which is processed by the vibration component processor; and
a central processing unit that controls timing of output of the output signal of the vibration detection element which is stored in the memory.

4. The vibration prevention control circuit according to claim 3, wherein
the central processing unit controls an operation of the vibration component processor.

5. The vibration prevention control circuit according to claim 1, wherein
the vibration component processor includes an integration process on the output signal of the vibration detection element which is digitized by the analog-to-digital converter circuit.

6. An imaging device comprising the vibration prevention control circuit according to claim 1, comprising:
the optical component;
the vibration detection element;
the position detection element; and
an optical component driving element that is connected to the vibration prevention control circuit and that drives the optical component according to the control signal.

7. A vibration prevention control circuit that drives an optical component of an imaging device according to vibration and that reduces influence of the vibration on imaging, the vibration prevention control circuit comprising:
at least one analog-to-digital converter circuit that samples and converts an output signal of a vibration detection element which detects vibration of the imaging device into a digital signal;
a vibration component processor that processes the output signal of the vibration detection element which is digitized by the analog-to-digital converter circuit;
a down-sampling unit that down-samples the output signal of the vibration detection element which is processed by the vibration component processor; and
a logic circuit that generates a control signal which drives the optical component, based on the output signal of the vibration detection element which is output from the down-sampling unit.

8. An imaging device comprising the vibration prevention control circuit according to claim 7, comprising:
the optical component;
the vibration detection element; and
an optical component driving element that is connected to the vibration prevention control circuit and that drives the optical component according to the control signal.
